(19) United States
(12) Patent Application Publication
(10) Pub. No.: US 2025/0366498 A1
(43) Pub. Date: Dec. 4, 2025

(54) FOOD PROCESSING DEVICE AND FOOD PROCESSING METHOD

(71) Applicant: Wistron Corporation, New Taipei City (TW)

(72) Inventors: Chia-Shyang HSU, New Taipei City (TW); Zhi-Gang CHEN, New Taipei City (TW); Chih-Chao HUANG, New Taipei City (TW); I-Chang HO, New Taipei City (TW)

(21) Appl. No.: 18/816,138

(22) Filed: Aug. 27, 2024

(30) Foreign Application Priority Data
May 29, 2024 (TW) 113119907

(51) Int. Cl. A23L 5/10; A47J 27/04

(52) U.S. Cl. CPC A23L 5/13; A47J 2027/043

(57) ABSTRACT

A food processing device includes a steam generation device, a hot water generation device, a processing region, and a control assembly. The steam generation device is configured to generate steam. The hot water generation device is configured to generate hot water. The processing region has a processing space. The control assembly is connected to the steam generation device, the hot water generation device, and the processing region. A food processing method is also provided and includes a preparation procedure and a multi-stage processing procedure. The multi-stage processing procedure includes multiple processing stages. Each of the processing stages includes injecting the steam into the processing space for a preset steam time and injecting a preset water amount of the hot water into the processing space.

### CROSS-REFERENCE TO RELATED APPLICATION

This non-provisional application claims priority under 35 U.S.C. § 119 (a) to patent application No. 113119907 filed in Taiwan, R.O.C. on May 29, 2024, the entire contents of which are hereby incorporated by reference.

### BACKGROUND

### Technical Field

The instant disclosure relates to a food processing device, especially to a food processing device having a steam generation device and a hot water generation device.

### Related Art

A food processing device known to the inventor adopts a large-size single boiler to heat water in order to simultaneously generate hot water and steam for processing food. In order to reduce the size of such a system, the size of the boiler and the size of the electrical system have to be limited, and therefore the time for generating the hot water and the steam is prolonged. As a result, the total time consumption over multiple food processing sessions is increased.

### SUMMARY

In order to address the above issues, some embodiments of the instant disclosure can reduce the time for the food processing device to generate hot water and steam. Therefore, according to some embodiments of the instant disclosure, the food processing device can prepare the hot water and the steam needed more quickly for a subsequent food processing session.

In some embodiments, a food processing method is adapted to process a food ingredient in a processing space. The food processing method comprises: performing a preparation procedure to obtain steam and hot water; and performing a multi-stage processing procedure. The multi-stage processing procedure comprises a plurality of processing stages, and each of the processing stages comprises: injecting the steam into the processing space for a preset steam time and injecting a preset water amount of the hot water into the processing space.

In some embodiments, a food processing device comprises a steam generation device, a hot water generation device, a processing region, and a control assembly. The steam generation device is configured to generate steam. The hot water generation device is configured to generate hot water. The processing region has a processing space. The control assembly is connected to the steam generation device, the hot water generation device, and the processing region. The control assembly is configured to perform a multi-stage processing procedure. The multi-stage processing procedure comprises a plurality of processing stages. Each of the processing stages comprises: injecting the steam into the processing space for a preset steam time and injecting a preset water amount of the hot water into the processing space.

In some embodiments, a food processing device comprises a steam generation device, a hot water generation device, a processing region, a nozzle, a driving assembly, a piping assembly, and a controller. The steam generation device comprises a steam outlet. The steam generation device is configured to output steam at the steam outlet. The hot water generation device comprises a hot water outlet. The hot water generation device is configured to output hot water at the hot water outlet. The processing region has a processing space. The nozzle has a nozzle outlet. The driving assembly is configured to actuate the nozzle to selectively dispose the nozzle outlet in and not in the processing space. The piping assembly is configured to selectively allow the steam outlet and the nozzle outlet to be in communication with each other through the piping assembly and to selectively allow the hot water outlet and the nozzle outlet to be in communication with each other through the piping assembly. The controller is configured to: drive the control assembly to actuate the nozzle so that the nozzle outlet is in the processing space; drive the piping assembly to allow the steam outlet and the nozzle outlet to be in communication with each other for a first preset steam time; and drive the piping assembly to allow the hot water outlet and the nozzle outlet to be in communication with each other until a first preset water amount of the hot water has been injected into the processing space.

As above, the multi-stage processing procedure of the food processing method according to some embodiments of the instant disclosure allows a to-be-processed food ingredient to be alternately soaked by the hot water and heated and stirred by the steam. Therefore, the food ingredient can be more effectively processed. Besides, because the total amounts of the hot water and the steam needed for processing are not respectively injected in a single injection, when the steam is being injected, the hot water can be generated (replenished); and when the hot water is being injected, the steam can be generated (replenished). Therefore, the preparation times for the hot water and the steam can be reduced.

### BRIEF DESCRIPTION OF THE DRAWINGS

The instant disclosure will become more fully understood from the detailed description given herein below for illustration only and therefore not limitative of the instant disclosure, wherein:

FIG. 1 illustrates a perspective view (front view) of a food processing device of an embodiment of the instant disclosure;

FIG. 2 illustrates a perspective view (back view) of a food processing device of an embodiment of the instant disclosure;

FIG. 3 illustrates a system block diagram of a food processing device of an embodiment of the instant disclosure;

FIG. 4 illustrates an interior side view (first viewing angle) of a food processing device of an embodiment of the instant disclosure;

FIG. 5 illustrates an interior side view (second viewing angle) of a food processing device of an embodiment of the instant disclosure;

FIG. 6 illustrates an interior top view of a food processing device of an embodiment of the instant disclosure;

FIG. 7 illustrates an enlarged partial view of a food processing device of an embodiment of the instant disclosure, showing detailed structures of a nozzle;

FIG. 8 illustrates a schematic view of a processing region of an embodiment of the instant disclosure, wherein a processing container is placed in the processing region, and the nozzle is not within the processing region;

FIG. 9 illustrates a schematic view of a processing region of an embodiment of the instant disclosure, wherein a processing container is placed in the processing region, and the nozzle is within the processing region (first position);

FIG. 10 illustrates a schematic view of a processing region of an embodiment of the instant disclosure, wherein a processing container is placed in the processing region, and the nozzle is within the processing region (second position);

FIG. 11 illustrates a flow chart of a food processing method of an embodiment of the instant disclosure; and

FIG. 12 illustrates a partial flow chart of a food processing method of an embodiment of the instant disclosure.

### DETAILED DESCRIPTION

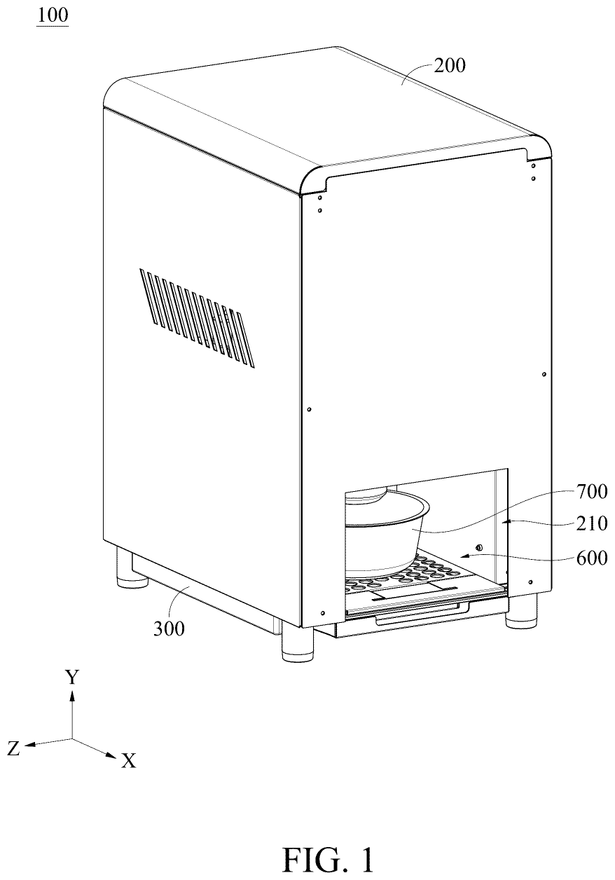

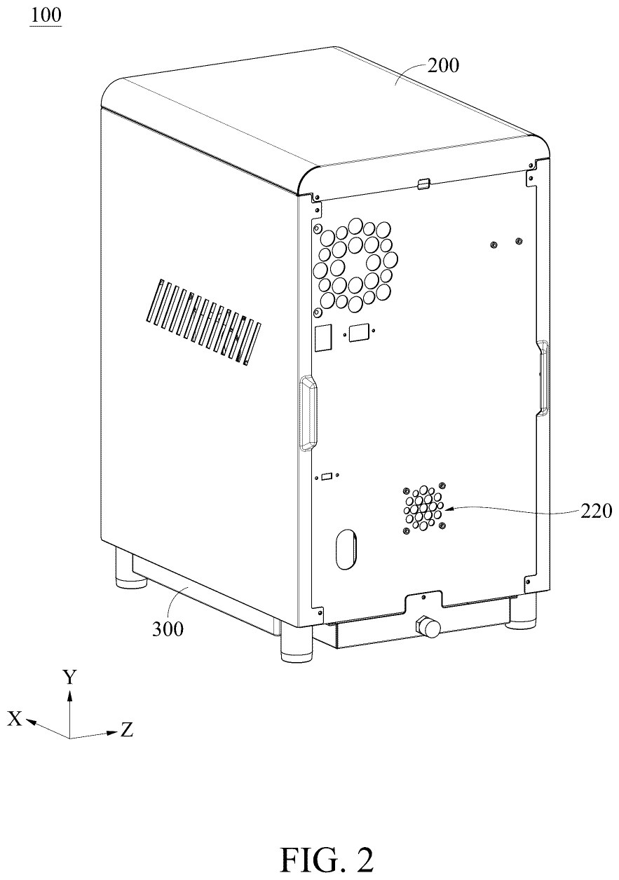

Please refer to FIG. 1 and FIG. 2. FIG. 1 illustrates a perspective view (front view) of a food processing device 100 of an embodiment of the instant disclosure. FIG. 2 illustrates a perspective view (back view) of the food processing device 100 of an embodiment of the instant disclosure. The food processing device 100 is configured to generate hot water and steam to process a food ingredient. In some embodiments, the food processing device 100 comprises a housing 200. An entrance 210 and an exhaust 220 are arranged on the housing 200, and the entrance 210 may be provided with a door (not shown in the drawings). The entrance 210 allows a user to place a processing container 700 in the food processing device 100 or take the processing container 700 out of the food processing device 100. The exhaust 220 allows hot air or steam generated during food processing or cleaning to be removed from the food processing device 100. In some embodiments, the food processing device 100 further comprises a drain tray 300 below the housing 200. The drain tray 300 is adapted to guide excessive water generated after food processing to perform consecutive processing. In some embodiments, the food processing device 100 further comprises a user interface (not shown in the drawings). The user interface can be on the housing 200 or be a control interface external to the housing 200.

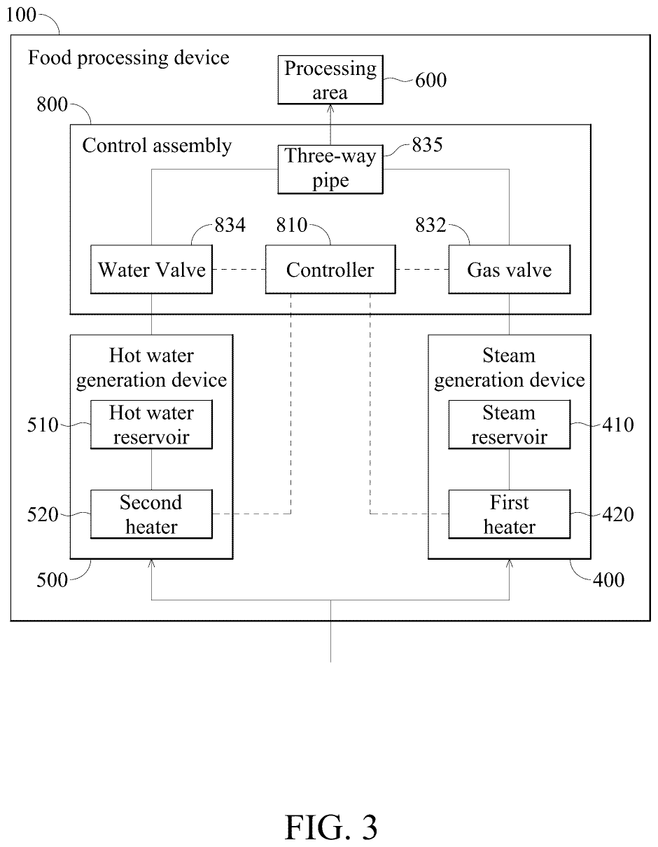

Please refer to FIG. 3. FIG. 3 illustrates a system block diagram of the food processing device 100 of an embodiment of the instant disclosure. In FIG. 3, solid lines between functional blocks indicate paths for liquid water or steam, and broken lines between the functional blocks indicate paths for electrical connections. In some embodiments, the food processing device 100 comprises a steam generation device 400, a hot water generation device 500, a processing region 600, and a control assembly 800. The steam generation device 400 is configured to generate steam when the steam generation device 400 is driven. The hot water generation device 500 is configured to generate hot water when the hot water generation device 500 is driven. The processing region 60 has a processing space 710. The control assembly 800 is connected to the steam generation device 400, the hot water generation device 500, and the processing region 600. The control assembly 800 is configured to perform a multi-stage processing procedure when the control assembly 800 is driven (described in detail later).

Please continue referring to FIG. 3. In some embodiments, the steam generation device 400 comprises a steam reservoir 410 and a first heater 420, and a volume of liquid water within the steam reservoir 410 is less than ¼ of a total capacity of the steam reservoir 410. Therefore, in this embodiment, the first heater 420 can heat the liquid water to a boiling point more quickly so as to increase an efficiency of steam generation of the steam generation device 400. In some embodiments, the steam generation device 400 is a steam boiler. In some embodiments, the steam reservoir 410 is connected to a steam pipe 831 (described in detail later) of a piping assembly 830 of the control assembly 800, and thus the steam from the steam reservoir 410 can be outputted through the steam pipe 831. In some embodiments, the first heater 420 is electrically connected to a controller 810 (described in detail later) of the control assembly 800, and thus the controller 810 can control the first heater 420 to perform heating and prepare the steam in accordance with demand(s). In some embodiments, the steam generation device 400 comprises a first steam outlet 430, and the steam generation device 400 is configured to output the steam at the first steam outlet 430 to the steam pipe 831.

Please continue referring to FIG. 3. In some embodiments, the hot water generation device 500 comprises a hot water reservoir 510 and a second heater 520. Because the hot water generation device 500 does not need to generate the steam, the second heater 520 does not need to heat the liquid water to the boiling point, and therefore an energy needed for the hot water generation device 500 to generate the hot water can be reduced. In some embodiments, the hot water generation device 500 is a hot water boiler. In some embodiments, the hot water reservoir 510 is connected to a water pipe 833 (described in detail later) of the piping assembly 830 of the control assembly 800, and thus the hot water from the hot water reservoir 510 can be outputted through the water pipe 833. In some embodiments, the second heater 520 is electrically connected to the controller 810 (described in detail later) of the control assembly 800, and thus the controller 810 can control the second heater 520 to perform heating and prepare the hot water in accordance with demand(s). In some embodiments, the hot water generation device 500 comprises a hot water outlet 530, and the hot water generation device 500 is configured to output the hot water at the hot water outlet 530.

In some embodiments, the food processing device 100 can perform a preparation procedure. At this time, the control assembly 800 controls the first heater 420 to heat the water to or above the boiling point to generate the steam, and the steam is stored in the steam reservoir 410. Besides, the control assembly 800 controls the second heater 520 to heat the water below the boiling point to generate the hot water, and the hot water is stored in the hot water reservoir 510.

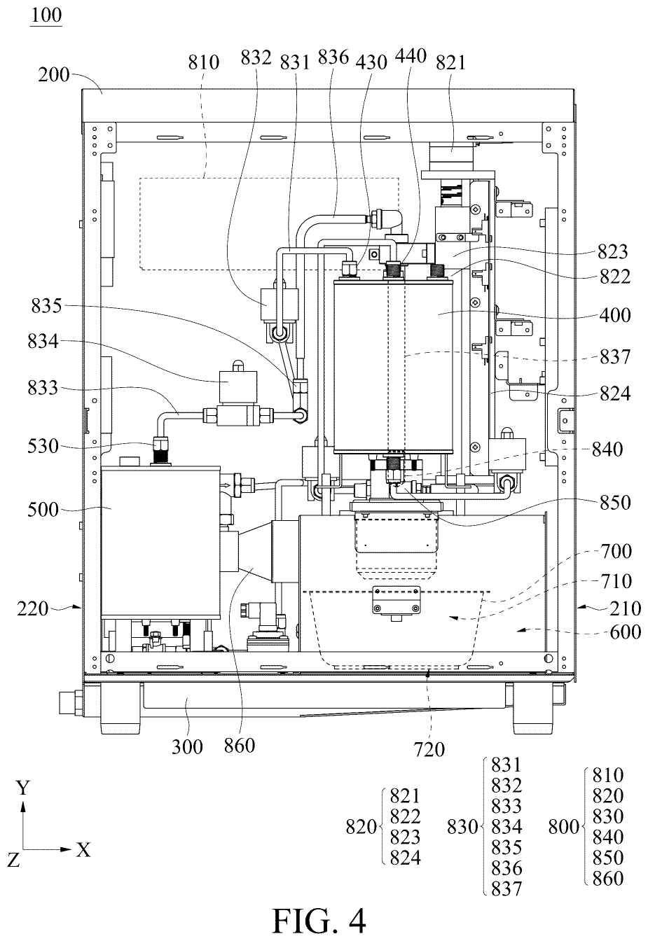

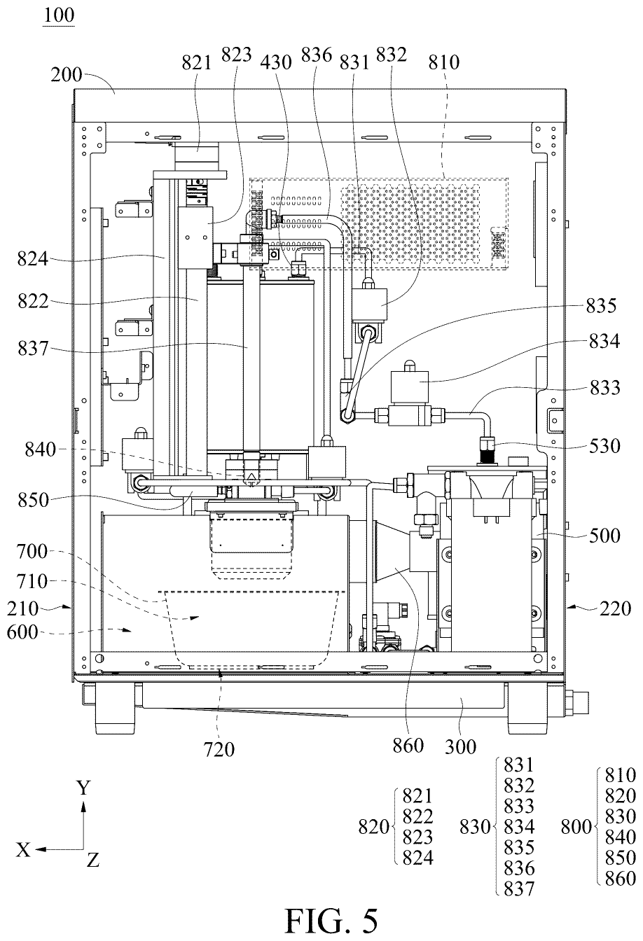

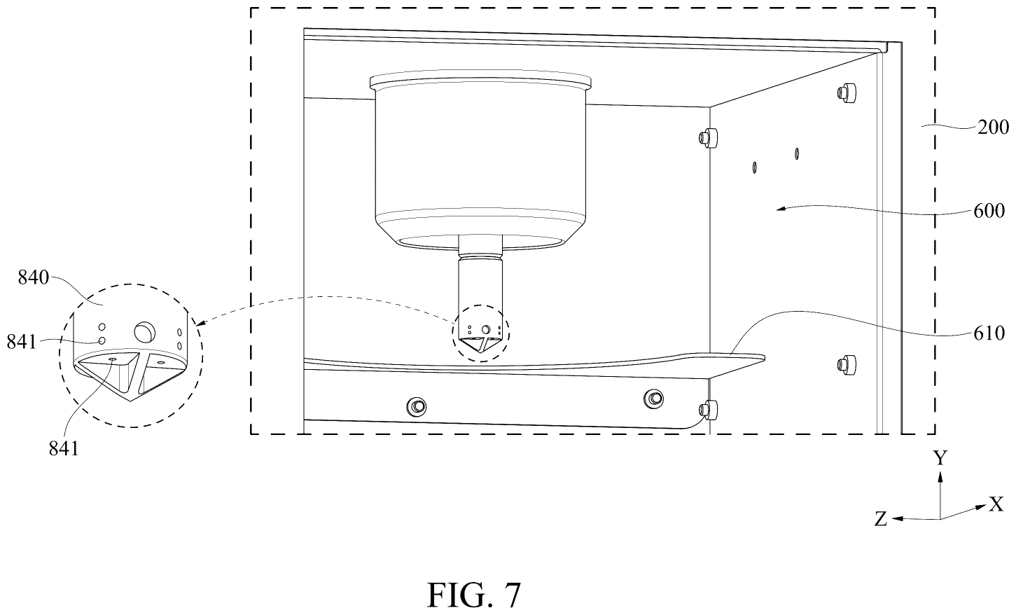

Please also refer to FIG. 4 and FIG. 5. FIG. 4 illustrates an interior side view (first viewing angle) of the food processing device 100 of an embodiment of the instant disclosure. FIG. 5 illustrates an interior side view (second viewing angle) of the food processing device 100 of an embodiment of the instant disclosure. In some embodiments, the processing space 710 is a space defined by a processing container 700, i.e., a space of the processing container 700 capable of containing an object. Therefore, different processing containers 700 will respectively define different processing spaces 710. In some embodiments, the processing region 600 has a fixation member 610 (FIG. 7 through FIG. 10), and the fixation member 610 allows the user to place the processing container 700 at a correct position in the processing region 600 conveniently. In some embodiments, the fixation member 610 defines an arc (in other words, in some embodiments, the fixation member 610 has an arc portion), and thus an outer profile of the processing container 700 can match with the fixation member 610. However, the fixation member 610 may also define other shapes for different processing containers 700.

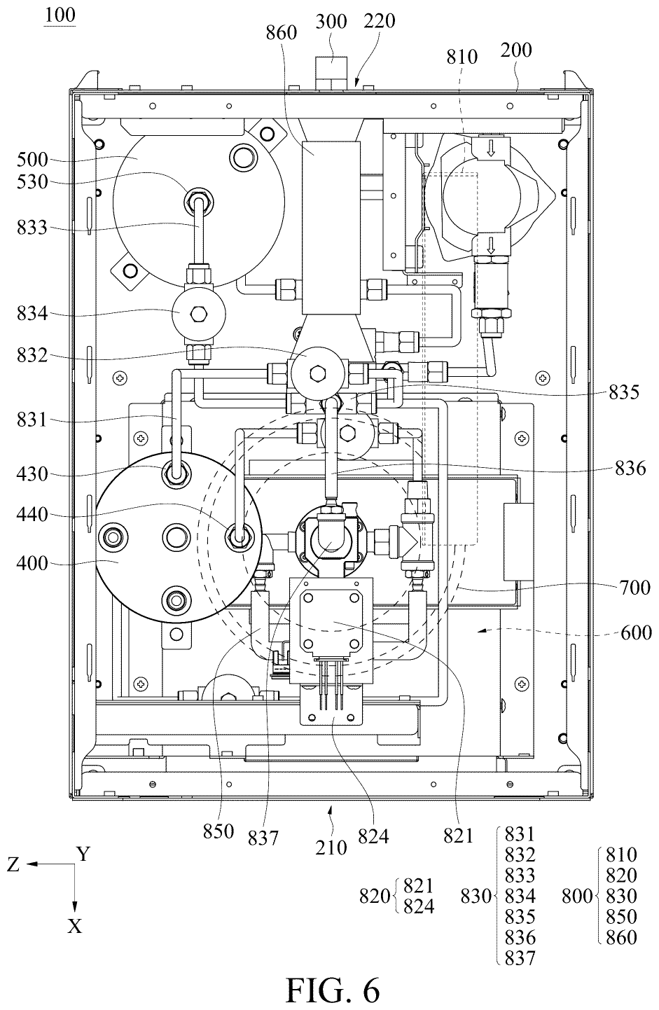

Please also refer to FIG. 6 and FIG. 7. FIG. 6 illustrates an interior top view of the food processing device 100 of an embodiment of the instant disclosure. FIG. 7 illustrates an enlarged partial view of the food processing device 100 of an embodiment of the instant disclosure, showing detailed structures of a nozzle 840. In some embodiments, the control assembly 800 comprises the nozzle 840, a driving assembly 820, the piping assembly 830, and the controller 810. The nozzle 840 has a nozzle outlet 841. When the driving assembly 820 is driven, the driving assembly 820 is configured to actuate the nozzle 840 to selectively dispose the nozzle outlet 841 in and not in the processing space 710. The piping assembly 830 is configured to selectively allow the steam generation device 400 and the processing region 600 to be in communication with each other through the piping assembly 830 and to selectively allow the hot water generation device 500 and the processing region 600 to be in communication with each other through the piping assembly 830.

Continuing from the previous paragraph, in some embodiments, the controller 810 is configured to drive the driving assembly 820 to actuate the nozzle 840 so that the nozzle outlet 841 is in the processing space 710, the controller 810 is configured to drive the piping assembly 830 to allow the steam generation device 400 and the nozzle outlet 841 to be in communication with each other for a first preset steam time, the controller 810 is configured to drive the piping assembly 830 to allow the hot water generation device 500 and the nozzle outlet 841 to be in communication with each other until a first preset water amount of the hot water has been injected into the processing space 710, the controller 810 is configured to drive the piping assembly 830 to allow the steam generation device 400 and the nozzle outlet 841 to be in communication with each other for a second preset steam time, and the controller 810 is configured to drive the piping assembly 830 to allow the hot water generation device 500 and the nozzle outlet 841 to be in communication with each other until a second preset water amount of the hot water has been injected into the processing space 710.

In some embodiments, the nozzle outlet 840 is configured as one or more end outlets, such as the outlets on a down-facing surface of the nozzle 840 shown in FIG. 7. In some embodiments, the nozzle outlet 840 is configured as a split outlet, such as the outlets on a side surface of the nozzle 840 shown in FIG. 7. In some embodiments, the nozzle outlet 841 comprises the end outlet and the split outlet at the same time. Besides, each of the nozzle outlets 841 may have identical or different sizes.

Please refer to FIG. 4 and FIG. 5. In some embodiments, the piping assembly 830 comprises a steam pipe 831, a gas valve 832, a water pipe 833, a water valve 834, and a three-way pipe 835. The steam pipe 831 is in communication with the steam generation device 400. The gas valve 832 is arranged at the steam pipe 831, and the controller 810 is electrically connected to the gas valve 832. The water pipe 833 is in communication with the hot water generation device 500. The water valve 834 is arranged at the water pipe 833, and the controller 810 is electrically connected to the water valve 834. The three-way pipe 835 is in communication with the steam pipe 831, the water pipe 833, and the nozzle 840. The gas valve 832 and the water valve 834 can be controlled by the controller 810 and thus allow or not allow the steam from the steam generation device 400 and the hot water from the hot water generation device 500 to be transported to the nozzle 840 and be injected into the processing space 710. Therefore, the steam and the hot water can be used to process the food ingredient within the processing space 710.

Please continue referring to FIG. 4 and FIG. 5. In some embodiments, the piping assembly 830 further comprises a guiding pipe 836 and an injection pipe 837 between the three-way pipe 835 and the nozzle 840. The steam and the hot water can be injected into the processing space 710 through the three-way pipe 835, the guiding pipe 836, the injection pipe 837, and the nozzle 840 sequentially.

Please continue referring to FIG. 4 and FIG. 5. In some embodiments, the driving assembly 820 comprises a driving element 821, a fixation rod 822, a movable block 823, and an assembly frame 824. The driving element 821 is electrically connected to the controller 810. The movable block 823 is movably arranged at the assembly frame 824 and pivotally arranged on the fixation rod 822, and the movable block 823 clamps the injection pipe 837. When the driving element 821 drives the movable block 823 to move with respect to the assembly frame 824 and the fixation rod 822, the injection pipe 837 is moved by the movable block 823, and thus the position of the nozzle 840 is adjusted. As a result, the nozzle 840 can be out of the processing region 600 or at different positions within the processing region 600 (with respect to the original position of the nozzle 840). In some embodiments, the position of the nozzle 840 is defined as the height of the nozzle 840. In some embodiments, the height of the nozzle 840 is defined as a vertical height of the nozzle 840.

For example, in an embodiment, the fixation rod 822 is a screw rod and is driven by the driving element 821 to rotate, and the movable block 823 is arranged on the fixation rod 822 and matches with the screw thread (not shown in the drawings) of the fixation rod 822. Therefore, when the driving element 821 drives the fixation rod 822 to rotate, the movable block 823 moves with respect to the assembly frame 824 and the fixation rod 822, and thus the position of the nozzle 840 is adjusted.

For example, in some embodiments, the assembly frame 824 has a rail (not shown in the drawings) or a magnetic element (not shown in the drawings), and the movable block 823 has a component (not shown in the drawings) which matches with the rail or the magnetic element of the assembly frame 824. Therefore, when the driving element 821 drives the rail or the magnetic element of the assembly frame 824, the movable block 823 moves with respect to the assembly frame 824 and the fixation rod 822, and thus the position of the nozzle 840 is adjusted.

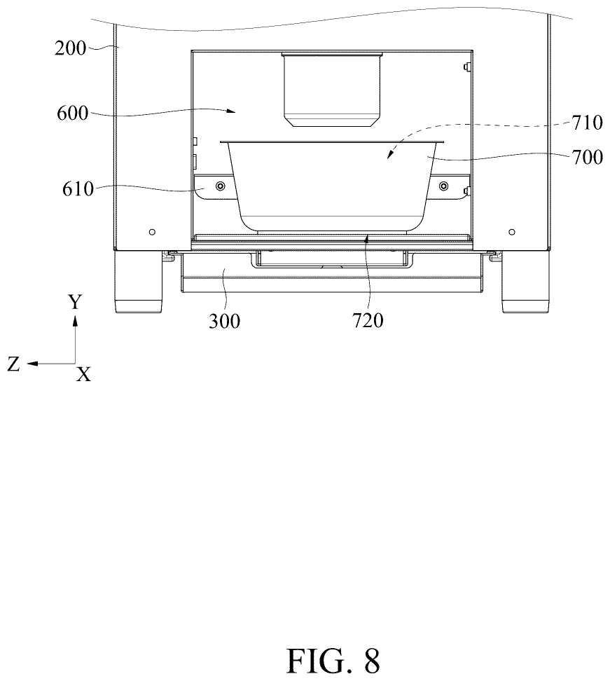

Please refer to FIG. 8. FIG. 8 illustrates a schematic view of the processing region 600 of an embodiment of the instant disclosure, wherein the processing container 700 is placed in the processing region 600, and the nozzle 840 is not within the processing region 600. When the nozzle 840 is not within the processing region 600, the nozzle 840 does not inject the hot water or the steam into the processing region 600. During this time, the food processing device 100 can perform the aforementioned preparation procedure or perform a cleaning procedure (described in detail later).

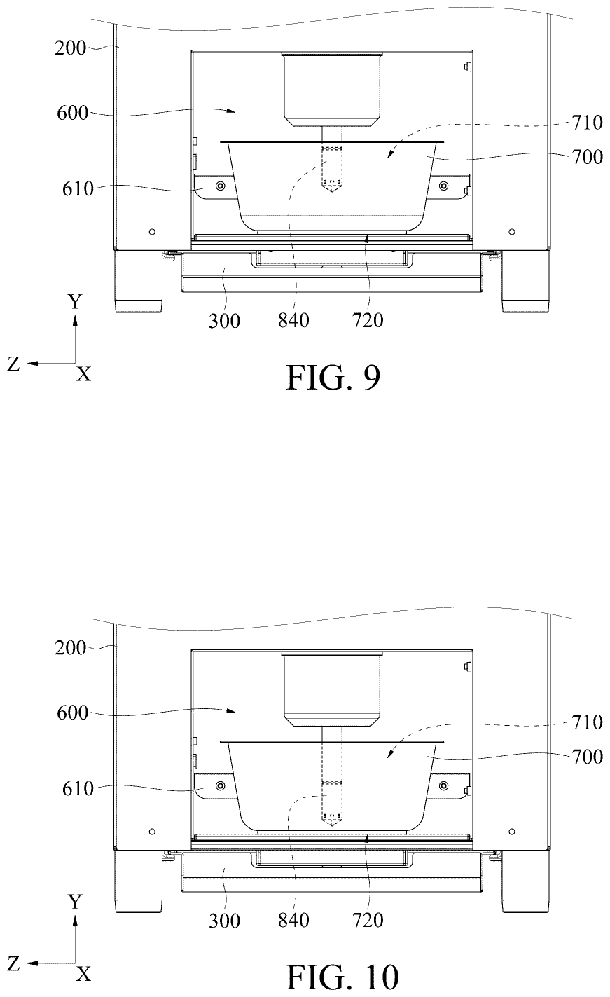

Please also refer to FIG. 9 and FIG. 10. FIG. 9 illustrates a schematic view of the processing region 600 of an embodiment of the instant disclosure, wherein the processing container 700 is placed in the processing region 600, and the nozzle 840 is within the processing region 600 (first position). FIG. 10 illustrates a schematic view of the processing region 600 of an embodiment of the instant disclosure, wherein the processing container 700 is placed in the processing region 600, and the nozzle 840 is within the processing region 600 (second position). It can be seen from these two drawings that the position of the nozzle 840 can be farther way from a container bottom 720 (FIG. 9) or closer to the container bottom 720 (FIG. 10). However, the position of the nozzle 840 is not limited to these two positions. In some embodiments, through the operation of the driving assembly 820, the nozzle 840 can be positioned at different positions within the processing space 710, and thus the food processing device 100 can achieve optimal food processing effect using the hot water and the steam at different positions.

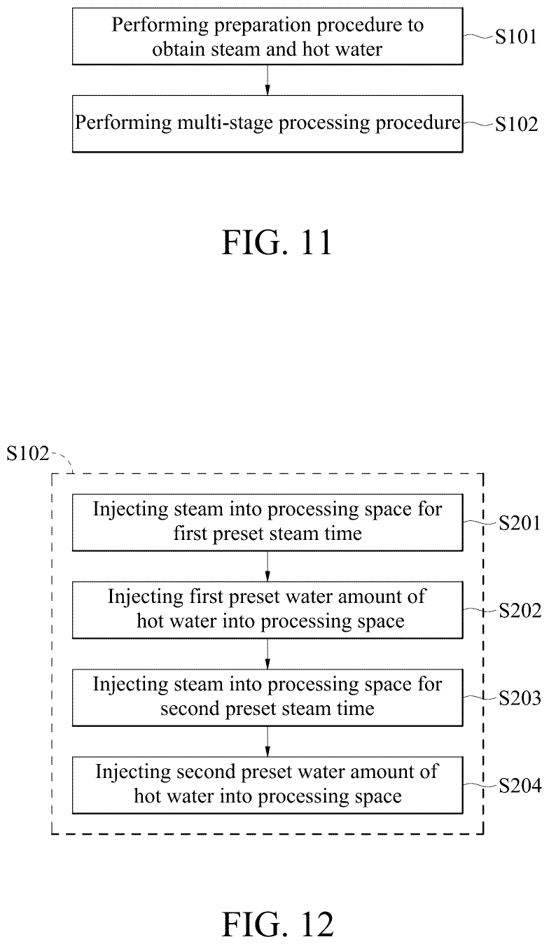

Please refer to FIG. 11. FIG. 11 illustrates a flow chart of a food processing method of an embodiment of the instant disclosure. In some embodiments, the food processing method is adapted to process the food ingredient in the processing space 710. The food processing method comprises step S101 and step S102. In the step S101, the controller 810 performs the preparation procedure to obtain the steam and the hot water. In the step S102, the controller 810 performs the multi-stage processing procedure. In some embodiments, the step S101 further comprises determining in accordance with a food processing procedure whether the hot water and the steam have met the demand of the food processing procedure. Therefore, in the step S101, whether more of the steam or the hot water should be replenished or the step S102 should be performed can be determined. In some embodiments, if the multi-stage processing procedure will first inject the hot water, the total amount of the steam is not needed to be prepared at once during the step S101. Similarly, in some embodiments, if the multi-stage processing procedure will first inject the steam, the total amount of the hot water is not needed to be prepared at once during the step S101.

Please also refer to FIG. 12. FIG. 12 illustrates a partial flow chart of a food processing method of an embodiment of the instant disclosure. In some embodiments, the multi-stage processing procedure comprises a plurality of processing stages (also referred to as processing procedure stages). Each of the processing stages comprises: injecting the steam into the processing space 710 for a preset steam time and injecting a preset water amount of the hot water into the processing space 710 (such as step S201 through the S204). In the step S201, the controller 810 actuates the gas valve 832 to be opened to inject the steam into the processing space 710 for a first preset stem time. In the step S202, the controller 810 actuates the water valve 834 to be opened to inject a first preset water amount of the hot water into the processing space 710. In the step S203, the controller 810 actuates the gas valve 832 to be opened to inject the steam into the processing space 710 for a second preset stem time. In the step S204, the controller 810 actuates the water valve 834 to be opened to inject a second preset water amount of the hot water into the processing space 710. The first preset steam time and the second preset steam time may be set in accordance with processing demands of different food ingredients and can be identical or different. Likewise, the first preset water amount and the second preset water amount may be set in accordance with the processing demands of different food ingredients and can be identical or different. In some embodiments, the multi-stage processing procedure comprises even more times of steam and hot water injections. By alternately using the steam and the hot water to heat and stir the food ingredients in accordance with demand(s), various food ingredients can all be most effectively processed. For example, the demand may be a type and a volume of the food ingredient.

In some embodiments, the multi-stage processing procedure merely comprises the step S201 and the step S202 described above.

In some embodiments, the step S202 further comprises: the controller 810 performs a steam preparation procedure to obtain the steam. In other words, in some embodiments, when the hot water is being injected, the first heater 420 can heat the liquid water so as to replenish the steam pressure consumed during the step S201, and thus the steam pressure will be enough for being used during the step S203.

In some embodiments, the amount of the hot water obtained during the preparation procedure is less than a summation of the first preset water amount and the second preset amount (a total preset water amount), and the step S203 further comprises: the controller 810 performs a hot water preparation procedure to obtain the hot water. In other words, in some embodiments, when the steam is being injected, the second heater 520 can heat the liquid water so as to replenish the hot water consumed during the step S202, and thus the hot water will be enough for being used during the step S204.

In some embodiments, the step S201 through the step S204 may be performed under the condition that the height of the nozzle 840 is fixed or not fixed in accordance with the demand(s). In other words, in some embodiments, during each of the step S201 through the step S204, the nozzle 840 may be positioned at a fixed height, or the nozzle 840 may be moved continuously, intermittently, back and forth, in a single stroke, or in multiple strokes. Besides, a moving speed of the nozzle 840 may be adjusted in accordance with the demand(s).

In some embodiments, the control assembly 800 further comprises a cleaning assembly 850. In some embodiments, the steam generation device 400 comprises a second steam outlet 440, and the steam generation device 400 is configured to output the steam at the second steam outlet 440 to the cleaning assembly 850. When the nozzle 840 is within the cleaning assembly 850, the controller 810 can control the steam generation device 400 to inject the steam through the second steam outlet 440 into the cleaning assembly 850 to clean the nozzle 840.

In some embodiments, the control assembly 800 further comprises an exhaust assembly 860. The exhaust assembly 860 is in communication with the processing region 600 and the exhaust 220 to extract excessive steam or hot air from the processing region 600 and discharge the excessive steam or hot air out of the food processing device 100.

As above, the multi-stage processing procedure of the food processing method according to some embodiments of the instant disclosure allows a to-be-processed food ingredient to be alternately soaked by the hot water and heated and stirred by the steam. Therefore, the food ingredient can be more effectively processed. Besides, because the total amounts of the hot water and the steam needed for processing are not respectively injected in a single injection, when the steam is being injected, the hot water can be generated (replenished); and when the hot water is being injected, the steam can be generated (replenished). Therefore, the preparation times for the hot water and the steam can be reduced.

Besides, the food processing device of some embodiments of the instant disclosure adopts separate heating devices to respectively generate the hot water and the steam, and the hot water and the steam can be respectively replenished in accordance with a demand during food processing. Therefore, it is not necessarily prepare all of the hot water and steam needed prior to food processing. Furthermore, the separate heating devices allow a volume of liquid water within the steam generation device to be less. As a result, the liquid water can reach the boiling point more quickly, and the preparation time for the steam can thus be greatly reduced. As above, the waiting time between each food processing session can be reduced, and thus the total time consumption over multiple food processing sessions can be reduced.

What is claimed is:

1. A food processing method adapted to process a food ingredient in a processing space,
wherein the food processing method comprises:
performing a preparation procedure to obtain steam and hot water; and
performing a multi-stage processing procedure, wherein the multi-stage processing procedure comprises a plurality of processing stages, and each of the processing stages comprises: injecting the steam into the processing space for a preset steam time and injecting a preset water amount of the hot water into the processing space.

2. The food processing method according to claim 1, wherein the step of injecting the preset water amount of the hot water into the processing space comprises performing a steam preparation procedure to obtain the steam.

3. The food processing method according to claim 1, wherein an amount of the hot water obtained during the preparation procedure is less than a total preset water amount, and the step of injecting the steam into the processing space for the preset steam time comprises performing a hot water preparation procedure to obtain the hot water.

4. The food processing method according to claim 1, wherein the injection steps of the multi-stage processing procedure is performed by a nozzle, the nozzle has a nozzle outlet, and the step of injecting the steam into the processing space for the preset steam time comprises injecting the steam into the processing space with the nozzle outlet at different heights within the processing space.

5. The food processing method according to claim 4, wherein the nozzle outlet is actuated to inject the steam into the processing space at different heights in a single stroke within the processing space.

6. The food processing method according to claim 4, wherein the nozzle outlet is actuated to inject the steam into the processing space back and forth at different heights within the processing space.

7. The food processing method according to claim 1, wherein the preset steam time in each of the processing stages are not identical to each other.

8. A food processing device comprising:
a steam generation device configured to generate steam;
a hot water generation device configured to generate hot water;
a processing region having a processing space; and
a control assembly connected to the steam generation device, the hot water generation device, and the processing region, wherein the control assembly is configured to perform a multi-stage processing procedure, the multi-stage processing procedure comprises a plurality of processing stages, and each of the processing stages comprises: injecting the steam into the processing space for a preset steam time and injecting a preset water amount of the hot water into the processing space.

9. The food processing device according to claim 8, wherein the control assembly comprises:
a nozzle having a nozzle outlet;
a driving assembly configured to actuate the nozzle to selectively dispose the nozzle outlet in and not in the processing space;
a piping assembly, wherein the piping assembly is configured to selectively allow the steam generation device and the processing region to be in communication with each other through the piping assembly and to selectively allow the hot water generation device and the processing region to be in communication with each other through the piping assembly; and
a controller configured to:
drive the control assembly to actuate the nozzle so that the nozzle outlet is in the processing space;
drive the piping assembly to allow the steam generation device and the processing region to be in communication with each other for a first preset steam time;
drive the piping assembly to allow the hot water generation device and the processing region to be in communication with each other until a first preset water amount of the hot water has been injected into the processing space;
drive the piping assembly to allow the steam generation device and the processing region to be in communication with each other for a second preset steam time; and
drive the piping assembly to allow the hot water generation device and the processing region to be in communication with each other until a second preset water amount of the hot water has been injected into the processing space.

10. The food processing device according to claim 9, wherein the piping assembly comprises:
a steam pipe in communication with the steam generation device;
a gas valve arranged at the steam pipe, wherein the controller is electrically connected to the gas valve;
a water pipe in communication with the hot water generation device;
a water valve arranged at the water pipe, wherein the controller is electrically connected to the water valve; and
a three-way pipe in communication with the steam pipe, the water pipe, and the nozzle.

11. The food processing device according to claim 10, wherein the nozzle outlet is an end outlet.

12. The food processing device according to claim 10, wherein the nozzle outlet is a split outlet.

13. The food processing device according to claim 8, wherein:
the steam generation device comprises a steam reservoir and a first heater, the steam reservoir is connected to the control assembly, the hot water generation device comprises a hot water reservoir and a second heater, the hot water reservoir is connected to the control assembly, and the first heater and the second heater are electrically connected the control assembly; and
when the food processing device performs a preparation procedure, the control assembly controls the first heater to heat water above a boiling point to generate the steam, the steam is stored in the steam reservoir, the control assembly controls the second heater to heat water below the boiling point to generate the hot water, and the hot water is stored in the hot water reservoir.

14. The food processing device according to claim 8, wherein the steam generation device is configured to generate the steam at the same time as the step of injecting the first preset water amount of the hot water into the processing space.

15. The food processing device according to claim 8, wherein the steam generation device is configured to generate the hot water at the same time as the step of injecting the steam into the processing space for the second preset steam time.

16. A food processing device comprising:
a steam generation device comprising a steam outlet, wherein the steam generation device is configured to output steam at the steam outlet;
a hot water generation device comprising a hot water outlet, wherein the hot water generation device is configured to output hot water at the hot water outlet;
a processing region having a processing space;
a nozzle having a nozzle outlet;
a driving assembly configured to actuate the nozzle to selectively dispose the nozzle outlet in and not in the processing space;
a piping assembly, wherein the piping assembly is configured to selectively allow the steam outlet and the nozzle outlet to be in communication with each other through the piping assembly and to selectively allow the hot water outlet and the nozzle outlet to be in communication with each other through the piping assembly; and
a controller configured to:
drive the control assembly to actuate the nozzle so that the nozzle outlet is in the processing space;
drive the piping assembly to allow the steam outlet and the nozzle outlet to be in communication with each other for a first preset steam time; and
drive the piping assembly to allow the hot water outlet and the nozzle outlet to be in communication with each other until a first preset water amount of the hot water has been injected into the processing space.

17. The food processing device according to claim 16, wherein after the step of driving the piping assembly to allow the hot water outlet and the nozzle outlet to be in communication with each other until the first preset water amount of the hot water has been injected into the processing space, the controller is further configured to:
drive the piping assembly to allow the steam outlet and the nozzle outlet to be in communication with each other for a second preset steam time; and
drive the piping assembly to allow the hot water outlet and the nozzle outlet to be in communication with each other until a second preset water amount of the hot water has been injected into the processing space.

18. The food processing device according to claim 17, wherein the steam generation device is configured to generate the hot water at the same time as the step of injecting the steam into the processing space for the second preset steam time.

19. The food processing device according to claim 16, wherein the steam generation device is configured to generate the steam at the same time as the step of injecting the first preset water amount of the hot water into the processing space.

20. The food processing device according to claim 16, wherein after the step of driving the piping assembly to allow the hot water outlet and the nozzle outlet to be in communication with each other until the first preset water amount of the hot water has been injected into the processing space, the controller is further configured to drive the control assembly to actuate the nozzle so that the nozzle outlet is not in the processing space.

21. The food processing device according to claim 16, wherein
the steam generation device comprises a steam reservoir and a first heater, the steam reservoir is connected to the piping assembly, the hot water generation device comprises a hot water reservoir and a second heater, the hot water reservoir is connected to the piping assembly, the steam reservoir communicates with the steam outlet, the hot water reservoir communicates with the hot water outlet, and the first heater and the second heater are electrically connected the control assembly; and
when the food processing device performs a preparation procedure, the controller controls the first heater to heat water above a boiling point to generate the steam, the steam is stored in the steam reservoir, the controller controls the second heater to heat water below the boiling point to generate the hot water, and the hot water is stored in the hot water reservoir.
